(19) United States
(12) Patent Application Publication
(10) Pub. No.: US 2026/0218840 A1
(43) Pub. Date: Jul. 30, 2026

(54) DISPLAY DEVICE MOUNTING BRACKET

(71) Applicant: NINGBO TUOTUO RIVER DESIGN COMPANY, Ningbo (CN)

(72) Inventors: Zhi Min Wang, Ningbo (CN); Jun Tang, Ningbo (CN)

(21) Appl. No.: 19/437,082

(22) Filed: Dec. 30, 2025

(30) Foreign Application Priority Data
Jan. 24, 2025 (CN) 202520172414.6

(51) Int. Cl. F16M 11/04; F16M 13/02

(52) U.S. Cl. CPC F16M 11/046; F16M 13/02; F16M 2200/048; F16M 2200/063; F16M 2200/068

(57) ABSTRACT

The present disclosure provides a display device bracket. The display device bracket can include a mounting base assembly comprising a mounting base; a panel assembly; a cantilever assembly including a support arm and a transmission mechanism, wherein two ends of the support arm are rotatably connected to the mounting base and the panel assembly respectively; an elastic member mounted inside the mounting base, wherein a first end of the transmission mechanism is disposed inside the mounting base and connected with the elastic member, and a second end of the transmission mechanism acts on the support arm; and an adjustment assembly disposed on the support arm and configured to move the second end of the transmission mechanism along the support arm to accommodate display devices of different weights. The elastic member provides a supporting force that allows the display device to be held at any position.

### CROSS-REFERENCE TO RELATED APPLICATIONS

This application claims the benefit of priority to CN Application No. 202520172414.6, filed Jan. 24, 2025, which is incorporated herein by reference in its entirety.

### TECHNICAL FIELD

The disclosure relates to the technical field of display support, and particularly relates to a display mounting bracket.

### BACKGROUND

Television brackets with adjustable load capacity and freely adjustable height mainly adopt gas spring structures or mechanical spring structures to achieve such functions. The gas spring or mechanical spring is generally arranged between the upper connecting plate and the lower connecting plate. However, this arrangement tends to cause the upper and lower connecting plates to have a relatively large and elongated structure. When used in a room with a low ceiling, if the upper and lower plates are too long, the television may easily collide with the ceiling when the bracket is retracted. As a result, the user may experience poor usability when performing free stop or lifting operations of the television bracket.

### SUMMARY

In order to overcome the above-mentioned technical problem, the present disclosure provides a display device mounting bracket, comprising: a mounting base assembly comprising a mounting base; a panel assembly; a cantilever assembly comprising a support arm and a transmission mechanism, two ends of the support arm being rotatably connected to the mounting base and the panel assembly, respectively; an extendable member mounted in the mounting base, a first end of the transmission mechanism being connected to the extendable member, and a second end of the transmission mechanism acting on the support arm; and an adjustment assembly provided on the support arm, the adjustment assembly being used for moving the second end of the transmission mechanism on the support arm to adapt to display devices of different weights, the extendable member providing a supporting force for keeping the support arm at any position via the transmission mechanism.

In some embodiments, the adjustment assembly comprises: an adjusting member provided on the support arm; and a moving member threadedly connected to the adjusting member, the transmission mechanism being connected to the moving member, and the moving member moving relative to the support arm by rotating the adjusting member to change a position of an action point of the extendable member on the support arm.

In some embodiments, the moving member is slidingly fitted to the support arm; and/or, the adjustment assembly further comprises an indicator, the support arm is provided with a scale strip, the moving member is provided with the indicator, the support arm is provided with a viewing window, and at least part of the indicator is shown through the viewing window.

In some embodiments, the support arm is provided with a clearance hole, the adjustment assembly further comprises a transmission member provided in the support arm, the adjusting member being connected to the transmission member, the transmission member being provided with an operating end, the operating end being visible through the clearance hole, and the transmission member driving the adjusting member to rotate by rotating the operating end.

In some embodiments, the transmission member comprises: a first gear, rotatably arranged on the support arm, wherein the first gear is provided with the operating end; and a second gear, rotatably arranged on the support arm, wherein the second gear is in meshing connection with the first gear, the second gear is connected with the adjusting member, and an axis of the first gear and an axis of the second gear are arranged at an angle.

In some embodiments, the mounting base assembly further comprises at least one guide member rotatably connected to the mounting base, and the transmission mechanism is wound around the at least one guide member.

In some embodiments, the guide member includes at least one sprocket wheel, and the transmission mechanism includes at least one chain; or the guide member includes at least one pulley, and the transmission mechanism includes at least one driving rope.

In some embodiments, the mounting base assembly comprises a plurality of guide members, and at least two of the guide members are arranged in a staggered manner in a direction from the mounting base to the panel assembly, and the transmission mechanism is wound around the at least two guide members in sequence, and a first guide member of the at least two guide members is located below the extendable member.

In some embodiments, the mounting base comprises: a rear plate; two side plates, wherein the two side plates are arranged at intervals on the rear plate, each of the side plates comprising a base plate and a baffle plate connected to the base plate, and the support arm is connected to the two baffle plates or to the two base plates; an upper cover plate connected to the base plate; and a lower cover plate connected to the base plate, wherein the upper cover plate and the lower cover plate are respectively located on two sides of the support arm, and the rear plate, the two side plates, the upper cover plate, the lower cover plate and the support arm form an enclosed space, the at least one guide member being connected between the two baffle plates, and the extendable member is mounted between the two base plates.

In some embodiments, the upper cover plate comprises a first plate section, a second plate section and a third plate section connected in sequence and arranged at an angle, the first plate section and the third plate section are located on both sides of the second plate section, the first plate section is located on top of the two base plates, the second plate section is located on the front side of the two base plates, and the third plate section is located on top of the two baffle plates; the lower cover plate comprises a fourth plate section and a fifth plate section connected and arranged at an angle, the fourth plate section is located on the front side of the two base plates and below the two baffle plates, and the fifth plate section is located on the bottom of the two base plates, and the support arm is rotatably connected with the two baffle plates.

In some embodiments, the support arm comprises: an upper connecting arm pivotally connected with the mounting base and the panel assembly at two ends thereof, respectively; a lower connecting arm pivotally connected with the mounting base and the panel assembly at two ends thereof, respectively, the upper connecting arm, the panel assembly, the lower connecting arm and the mounting base forming a quadrilateral mechanism; and/or the mounting base assembly further comprises a connecting member arranged on the mounting base, and an end of the extendable member away from the transmission mechanism is connected with the connecting member.

In some embodiments, the extendable member is an elastic member, and the elastic member is a mechanical spring or a gas spring.

In some embodiments, the extendable member is a linear actuator.

In some embodiments, a handle is arranged on the panel assembly, the handle is movable or rotatable relative to the panel assembly, and a portion or the entirety of the handle can be hidden behind the display when the panel assembly is mounted on the display.

In some embodiments, a temperature detecting device is arranged on the panel assembly; and/or wherein a handle is arranged on the panel assembly, a temperature detecting device is arranged on the handle.

In some embodiments, wherein at least one of the mounting base, the panel assembly and the support arm is provided with a light source.

In some embodiments, a limit member is provided on one of the support arm and the panel assembly, and when the support arm is swung to the storage state, the limit member is in contact with the other of the support arm and the panel assembly to drive the panel assembly to rotate

Optionally, in other embodiments, a display device mounting bracket, comprising: a mounting base assembly comprising a mounting base adapted to be mounted on a wall; a panel assembly; a cantilever assembly comprising a support arm and a transmission mechanism, two ends of the support arm being rotatably connected to the mounting base and the panel assembly respectively; an extendable member, an expansion direction of the extendable member being substantially parallel to the wall, a first end of the transmission mechanism being connected to the extendable member and a second end of the transmission mechanism being connected to the support arm; an adjustment assembly provided on the support arm, the adjustment assembly being used for moving the second end of the transmission mechanism on the support arm to adapt to display devices of different weights, the extendable member providing a support force for keeping at any position to the support arm through the transmission mechanism.

Optionally, in other embodiments, a display device mounting bracket, comprising: a mounting base assembly comprising a mounting base; a panel assembly; a cantilever assembly comprising a support arm and a transmission mechanism, two ends of the support arm being rotatably connected to the mounting base and the panel assembly respectively; an actuating device, the actuating device being mounted on the base, a first end of the transmission mechanism being connected to the actuating device and a second end of the transmission mechanism being connected to the support arm; an adjustment assembly provided on the support arm, the adjustment assembly being used for moving the second end of the transmission mechanism on the support arm to adapt to display devices of different weights, the actuating device providing a support force for keeping at any position to the support arm through the transmission mechanism.

By applying the technical solutions of the present disclosure, the extendable member or the actuating device can be disposed within the base, one end of the transmission mechanism can be connected to the support arm, and the other end of the transmission mechanism can be arranged within the base and connected to the extendable member. This configuration changes the conventional layout in which the extendable member is arranged inside the support arm, thereby reducing the volume and length of the support arm and making the structure more compact. It is particularly suitable for use in environments with limited space, such as rooms with low ceilings, and thus improves the user experience.

### BRIEF DESCRIPTION OF THE DRAWINGS

The accompanying drawings, which are included to provide a further understanding of the present invention, illustrate embodiments of the present disclosure and together with the description serve to explain the present disclosure. The drawings provide example embodiments and those skilled in the art can implement the present technology in other embodiments without departing from the scope of the present disclosure. In the drawings:

FIG. 1 shows a structural schematic diagram of an embodiment of a display device mounting bracket in accordance with the present disclosure;

FIG. 2 shows an exploded structural schematic diagram of the display device mounting bracket of FIG. 1;

FIG. 3 shows an exploded structural schematic diagram of the support arm and the mounting base of the display device mounting bracket of FIG. 1;

FIG. 4 shows a structural schematic diagram of an adjustment assembly of the display device mounting bracket of FIG. 1;

FIG. 5 shows a structural schematic diagram of the mounting base assembly, the elastic member and the transmission mechanism of the display device mounting bracket of FIG. 1;

FIG. 6 shows an exploded structural schematic diagram of the mounting base assembly, the elastic member and the transmission mechanism of the display device mounting bracket of FIG. 1;

FIG. 7 shows an exploded structural schematic diagram of a transmission member of the adjustment assembly of the display device mounting bracket of FIG. 4;

FIG. 8 shows a structural schematic diagram of another view of the adjustment assembly of the display device mounting bracket of FIG. 4;

FIG. 9 shows an exploded structural schematic diagram of the adjustment assembly of the display device mounting bracket of FIG. 4;

FIG. 10 shows a structural schematic diagram of another view of the display device mounting bracket of FIG. 1;

FIG. 11 shows a structural schematic diagram of still another view of the display device mounting bracket of FIG. 1;

FIG. 12 shows a sectional view of the display device mounting bracket of FIG. 1 in which the panel assembly is in the highest position;

FIG. 13 shows a sectional view of the display device mounting bracket of FIG. 1 in which the panel assembly is in the lowest position);

FIG. 14 shows an exploded structural schematic diagram of another embodiment of a display device mounting bracket in accordance with the present disclosure;

FIG. 15 shows a sectional structural diagram of the display device mounting bracket of FIG. 14;

FIG. 16 shows a structural schematic diagram of an embodiment of a display device mounting bracket with a temperature sensor and a light source;

FIG. 17 shows a structural schematic diagram of an embodiment of a display device mounting bracket with a foldable handle in which the handle is in an extended state in accordance with the present disclosure;

FIG. 18 shows a schematic diagram of the display device mounting bracket of FIG. 17 in which the handle is in a folded state;

FIG. 19 shows a schematic diagram of an embodiment of a display device mounting bracket with a limit member in accordance with the present disclosure;

FIG. 20 shows a structural schematic diagram of yet another embodiment of a display device mounting bracket in accordance with the present disclosure.

### DETAILED DESCRIPTION

It should be noted that, unless otherwise specified, the embodiments of the present disclosure and the features of the embodiments described herein may be combined with each other as long as there is no conflict. The present disclosure will be described in detail below with reference to the accompanying drawings and in conjunction with the embodiments.

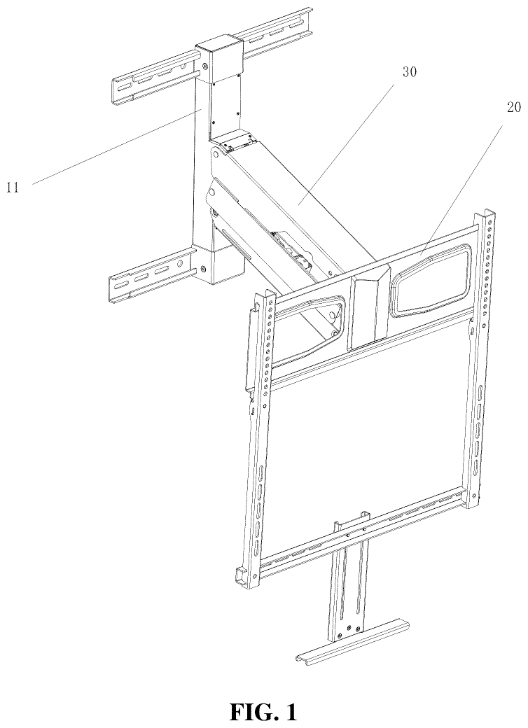

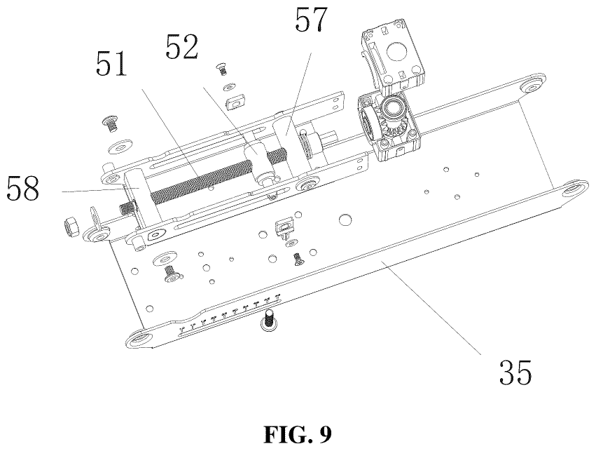

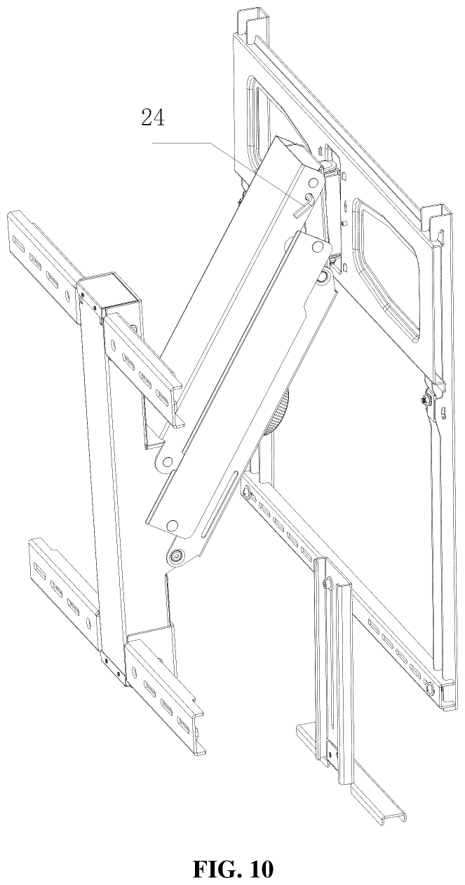

As shown in FIG. 1 to FIG. 13, a first embodiment of the present disclosure provides a display device mounting bracket. The display device mounting bracket includes: a mounting base assembly, including a mounting base 11; a panel assembly 20; a cantilever assembly, including a support arm 30 and a transmission mechanism 40; an elastic member 12; and an adjusting assembly 50. The adjusting assembly 50 can be located within the support arm 30. The two ends of the support arm 30 are respectively connected with the mounting base 11 and the panel assembly 20 by a rotary connection. The elastic member 12 is installed in the mounting base 11. The first end of the transmission mechanism 40 is set in the mounting base 11 and is connected with the elastic member 12 The second end of the transmission mechanism 40 acts on the support arm 30. The adjusting assembly 50 can be used to make the second end of transmission mechanism 40 move on support arm 30 to adapt to display devices of different weights. The elastic member 12 can be kept in any selected position by transmission mechanism 40 providing a supportive force to the support arm 30.

In the illustrated embodiment, the elastic member 12 is arranged in the mounting base 11, one end of the transmission mechanism 40 is connected with the support arm 30, and the other end of the transmission mechanism 40 is arranged in the mounting base 11 and connected with the elastic member 12, so that the layout of arranging the elastic element 12 in the support arm 30 in the traditional display device mounting bracket can be changed, the volume and length of the support arm 30 can be reduced, the support arm 30 is more compact, and the display device mounting bracket is particularly suitable for use in an environment with limited space, such as a room with a low ceiling, and the user experience can be improved.

Further, by adjusting the position of the second end of the transmission mechanism 40 on the support arm 30, the point of action of the elastic member 12 on the support arm 30 can be changed, so that the user can easily adjust the bearing state of the display device mounting bracket according to the different weights and sizes of the display device, ensuring that display devices of different sizes can be stably placed in any position, and improving the user experience.

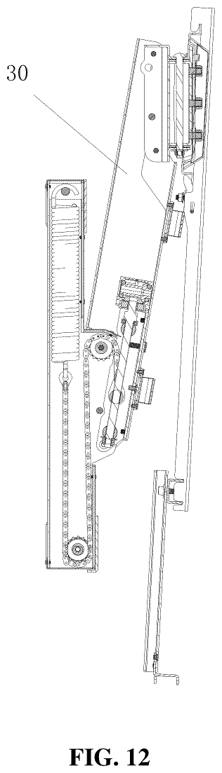

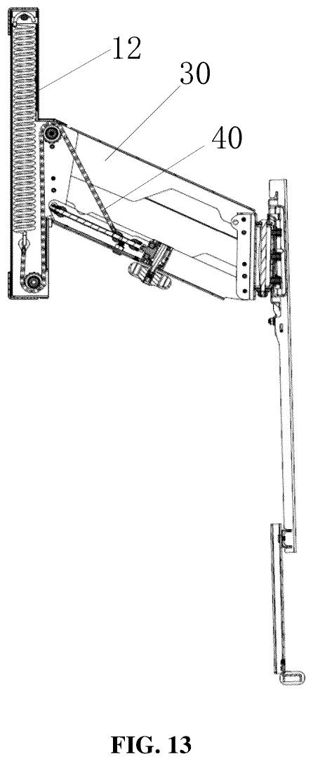

As shown in FIG. 12 and FIG. 13, in some embodiments of the present disclosure, the elastic member 12 is a mechanical spring, and the mechanical spring is vertically installed in the mounting base 11.

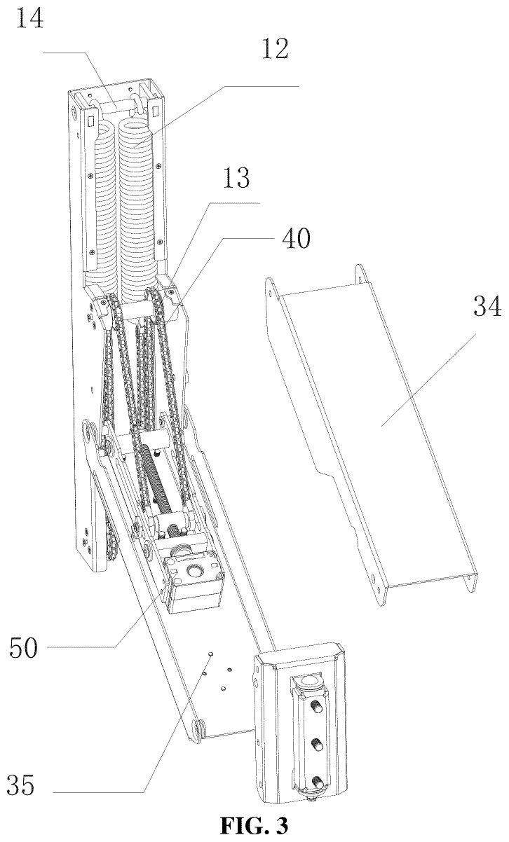

As shown in FIG. 3, in some embodiments of the present disclosure, the mounting base assembly further comprises at least one guide member 13. The guide member 13 can be rotatably arranged on the mounting base 11, and the transmission mechanism 40 can be arranged around the at least one guide member 13.

Through the arrangement illustrated in FIG. 3, the transmission mechanism 40 can be ensured to move smoothly along the predetermined path during force transmission, thereby improving the efficiency and stability of force transmission.

Further, the guide member 13 can be arranged in the force transmission path, and the guide member 13 can support the transmission mechanism 40 to reduce the direct friction between the transmission mechanism 40 and other parts of the bracket, especially when moving and bearing changes. This not only reduces the wear rate, but also effectively prolongs the service life of the entire bracket.

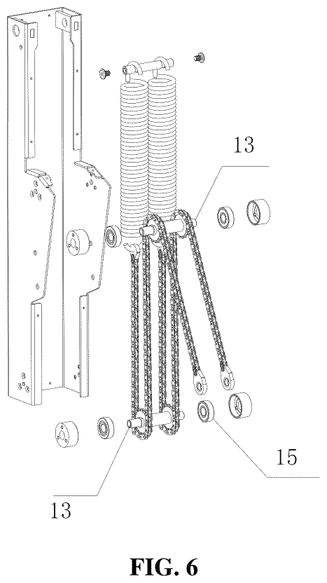

As shown in FIGS. 3 and 6, in some embodiments of the present disclosure, the mounting base assembly comprises a plurality of guide members 13. At least two guide members 13 can be arranged in a staggered manner from the mounting base 11 to the panel assembly 20. The transmission mechanism 40 can be sequentially arranged around the at least two guide members 13. A first guide member 13 of the at least two guide members 13 can be located below the elastic member 12.

In the embodiment illustrated in FIGS. 3 and 6, the staggered guide members 13 can ensure that the transmission mechanism 40 can smoothly move by each guide member 13 during force transmission, thereby ensuring uniform force distribution, which helps to improve the responsiveness and efficiency of the elastic member 12, ensures uniform force on the display during lifting and lowering, and avoids instability and potential damage caused by local excessive force.

Further, arranging the first guide member 13 below the elastic member 12 can optimize the space layout inside the entire mounting base to more effectively utilize the internal space of the mounting base. This layout can reduce the volume of the cantilever assembly, making the bracket more compact and suitable for use in limited spaces, such as wall-mounted installation in narrow rooms or work areas.

Further, the staggered guide members 13 help to enhance the structural stability of the entire bracket. By reasonably distributing the positions of the guide members 13, it can be ensured that the force state of the cantilever assembly is more balanced when the display device mounting bracket bears displays of different weights, avoiding stability problems caused by structural imbalance.

In some embodiments of the present disclosure, the number of guide members 13 is two. The first guide member 13 of the two guide members 13 is located below the elastic member 12, the second guide member 13 of the two guide members 13 is located above the first guide member 13, and the second guide member 13 is positioned on one side of the elastic member 12 toward the panel assembly 20.In some embodiments, the number of guide members 13 can be 1, or can be greater than 2.

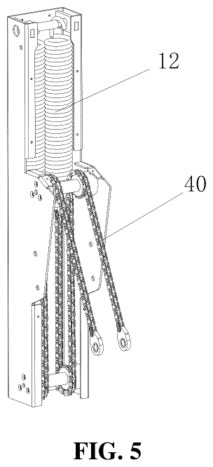

As shown in FIG. 5 and FIG. 6, in some embodiments of the present disclosure, the guide member 13 includes at least one sprocket wheel, and the transmission mechanism 40 includes at least one chain engaged with the at least one sprocket wheel.

In the embodiment illustrated in FIGS. 5 and 6, the chain and the sprocket wheel are used in cooperation, so that the force can be transmitted stably and efficiently. The meshing characteristics of the sprocket wheel and the chain can more effectively reduce the energy loss in force transmission than a rope or a belt, thereby improving the response speed and the bearing capacity of the whole display device mounting bracket.

Further, the sprocket wheel and the chain can be arranged so that the position adjustment of transmission mechanism 40 becomes simpler. When the bearing state of the display is adjusted, the chain can more accurately control the pre-tightening force of elastic member 12, and the sprocket wheel can serve as a guide to ensure that the chain does not derail in the adjustment process.

In some embodiments of the present disclosure, the number of elastic members 12 is two, transmission mechanism 40 includes two chains, and the two elastic members 12 and two chains are arranged correspondingly such that each chain is connected to one of the elastic members 12. Each guide member 13 can include the support shaft that is rotationally connected to the mounting base 11 and two chain wheels at the outer periphery of the support shaft. The two chains can be respectively arranged around the outer periphery of the two sprocket wheels. Both ends of each support shaft can be respectively equipped with a first bearing 15, and the support shaft can be rotationally connected with the mounting base 11 through the two first bearings 15.

In some embodiments, the number of elastic members 12 is one. Correspondingly, the transmission mechanism 40 can include one chain, and each guide member 13 can include a support shaft and one sprocket wheel rotationally connected to the outer periphery of the support shaft.

In some embodiments, transmission mechanism 40 can also include at least one pulley, and guide member 13 can also include at least one transmission rope engaged with the at least one pulley.

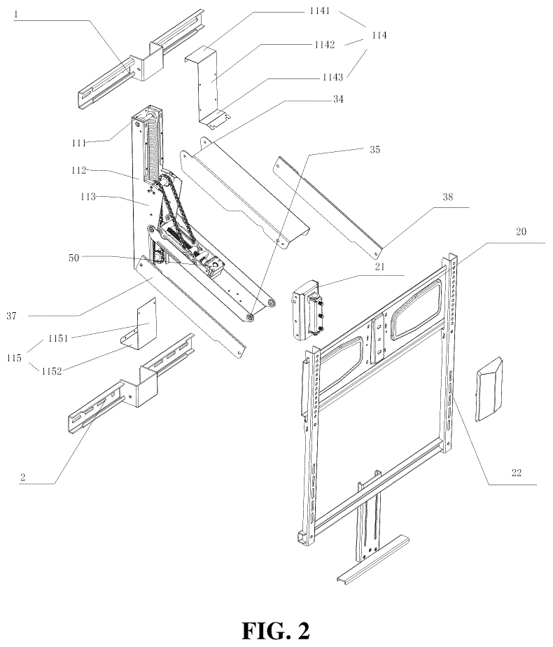

As shown in FIG. 2, in some embodiments of the present disclosure, mounting base 11 includes: a rear plate 111 and two side plates 37 and 38 arranged at intervals on the rear plate 111. Each side plate can include a base plate 112 and a baffle plate 113 connected with the base plate 112. The support arm 30 can be connected to the two baffle plates 113. An upper cover plate 114 can be connected with the base plate 112 and a lower cover plate 115 can be connected with the base plate 112. The upper cover plate 114 and the lower cover plate 115 can be respectively located on the two sides of the support arm 30. The rear plate 111, the two side plates 37 and 38, the upper cover plate 114, the lower cover plate 115 and the support arm 30 can at least partially enclose a substantially closed space. At least one guide member 13 can be connected between the two baffle plates 113, and the elastic member 12 can be mounted between the two base plates 112.

In the embodiment illustrated in FIG. 2, the closed design of the mounting base 11 can effectively protect the internal guide member 13, the elastic member 12 and other mechanical components from external environmental factors such as dust and moisture, prolong the service life of the components, and reduce the maintenance frequency and cost.

Further, the rear plate 111, the two side plates 37 and 38, the upper cover plate 114 and the lower cover plate 115 can be enclosed to form a rigid frame, so that the frame can effectively resist external impact and deformation, can ensure the stability of the whole support under various use conditions, and can avoid exposure of the internal mechanical structure. Additionally, the overall appearance of the display device mounting bracket can be improved.

Further, the elastic member 12 can be mounted between the two base plates 112, so that the internal space of the mounting base can be effectively utilized, the whole support can maintain a compact shape while ensuring the bearing capacity, and the support is suitable for environments with limited space.

Specifically, as shown in FIG. 2, in some embodiments of the present disclosure, the upper cover plate 114 includes a first plate section 1141, a second plate section 1142 and a third plate section 1143 which are sequentially connected and arranged at an angle. The first plate section 1141 and the third plate section 1143 can be located on both sides of the second plate section 1142, the first plate section 1141 can be located on the top of the two base plates, the second plate section 1142 can be located on the front side of the two base plates, the second plate section 1142 can be located on the side of the two base plates away from the rear plate 111, and the third plate section 1143 can be located on the top of the two baffle plates 113. The lower cover plate 115 can include a fourth plate section 1151 and a fifth plate section 1152 which are connected and arranged at an angle. The fourth plate section 1151 can be located on the front side of the two base plates 112 and below the two baffle plates 113, the fifth plate section 1152 can be located on the bottom of the two base plates 112, and the support arm 30 can be rotationally connected with the two baffle plates 113, so that the mounting base 11 can be closed.

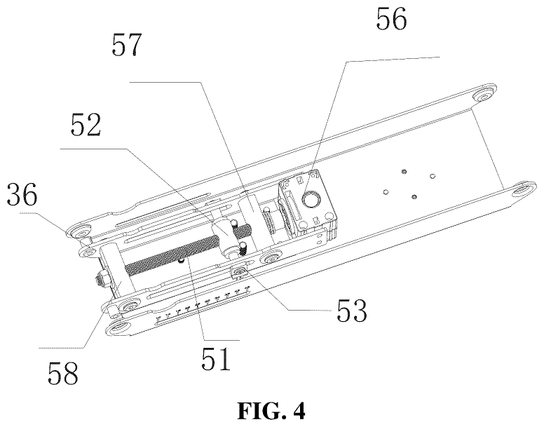

As shown in FIGS. 3 and 4, in some embodiments of the present disclosure, the adjustment assembly 50 includes: an adjusting member 51 arranged in the support arm 30; and a moving member 52 threadedly connected with the adjusting member 51. The transmission mechanism 40 can be connected with the moving member 52, such that the adjusting member 51 can be rotated and the moving member 52 can correspondingly be moved relative to the support arm 30 to change the acting point position of the elastic member 12 on the support arm 30.

In the embodiment illustrated in FIGS. 3 and 4, the adjusting member 51 can be rotated to accurately control the position of the moving member 52 in the support arm 30, so as to change the acting point position of the elastic member 12 on the support arm. In this manner, the user can easily adjust the bearing state of the support according to the different weights and sizes of the display device, the display device of different sizes can be stably stayed at any position, and the user experience is improved.

Specifically, in some embodiments of the present disclosure, the change of the position of the moving member 52 substantially adjusts the force arm of the elastic member 12 to the support arm 30 and the size of the elastic support force provided by the elastic member 12.

Further, the adjusting member 51 and the moving member 52 are arranged inside the support arm 30, thereby reducing the influence of external factors such as dust and moisture on the adjustment assembly, prolonging the service life, and reducing maintenance costs.

As shown in FIGS. 2 and 3, in some embodiments of the present disclosure, the support arm 30 comprises: an upper connecting arm 34; and a lower connecting arm 35. Both ends of the upper connecting arm 34 can be pivotally connected with the mounting base 11 and the panel assembly 20 respectively. Both ends of the lower connecting arm 35 can be pivotally connected with the mounting base 11 and the panel assembly 20 respectively. The upper connecting arm 34, the panel assembly 20, the lower connecting arm 35 and the mounting base 11 can accordingly form a quadrilateral mechanism.

In the embodiment illustrated in FIGS. 2 and 3, the upper connecting arm 34 and the lower connecting arm 35 are pivotally connected with the mounting base 11 and the panel assembly 20 respectively to form the quadrilateral mechanism, so that a more stable support structure can be provided. The quadrilateral mechanism can more evenly distribute the load under the weight of the display device, reduce the possibility of structural deformation and shaking, and ensure the stability of the display device at different positions.

Further, the quadrilateral mechanism can be formed such that when the panel assembly 20 is pulled up and down, the panel assembly 20 continues to face forward (e.g., parallel to and/or away from the mounting base 11).

Further, the quadrilateral mechanism can change the angle between the upper connecting arm 34 and the lower connecting arm 35, so that the height and the inclination angle of the panel assembly 20 can be adjusted more freely, so that the user can flexibly adjust the position of the display device according to individual needs, and the comfort and convenience of use are improved.

Further, through the pivotal connection, the upper connecting arm 34 and the lower connecting arm 35 can balance and distribute the gravity of the display device and the reverse force generated by the elastic member 12 to the mounting base 11 and the panel assembly 20, ensuring balanced force distribution, avoiding excessive load on a single connection point, and improving the structural safety and service life of the entire bracket.

Specifically, as shown in FIG. 2, in some embodiments of the present application, the support arm 30 further comprises a left side plate 37 and a right side plate 38. The left side plate 37 and the right side plate 38 can be arranged on opposing sides of the upper connecting arm 34 and the lower connecting arm 35 respectively to shield the gap between the upper connecting arm 34 and the lower connecting arm 35, and the internal structure cannot be seen from the side.

Specifically, as shown in FIG. 4, in some embodiments of the present application, two mounting plates 36 are arranged on the lower connecting arm 35. The two mounting plates 36 can be arranged along a direction in which the axes of the two mounting plates 36 are arranged at an angle. The adjustment assembly 50 can further comprise a first connecting shaft 57 and a second connecting shaft 58 fixed between the two mounting plates 36. The first connecting shaft 57 and the second connecting shaft 58 can be arranged along the axis of the adjusting member 51, and both ends of the adjusting member 51 can be rotatably connected with the first connecting shaft 57 and the second connecting shaft 58 respectively.

In some embodiments, the adjusting member 51 is a screw rod, the screw rod is sequentially arranged through the first connecting shaft 57, the moving member 52 and the second connecting shaft 58. The end of the screw rod can be locked on the second connecting shaft 58 through a nut.

Specifically, as shown in FIG. 10, in some embodiments the upper connecting arm 34 (see FIG. 2) and the panel connector 21 (see FIG. 2) are both provided with holes, and the display device mounting bracket further comprises a limit wrench 24. The limit wrench 24 passes through the holes on the upper connecting arm 34 and the panel connector 21 to prevent the upper connecting arm 34 and the panel connector 21 from rotating. In this configuration, the display device can be hung conveniently, and the space for adjusting the force value by hand is also increased, and when the adjusted force value matches the weight of the display device, the limit wrench 24 can be removed.

As shown in FIG. 4, in some embodiments of the present disclosure, the moving member 52 is slidingly coupled with the support arm 30. In the embodiment illustrated in FIG. 4, the sliding mechanism allows the moving member 52 to move smoothly inside the support arm 30, thereby providing a smooth experience for the user when adjusting the height of the display device, preventing jamming or unstable movement, and improving the comfort and efficiency of the adjustment process. In addition, the moving member 52 is slidingly coupled with the support arm 30, and during the rotation of the adjusting member 51, the support arm 30 can limit the rotation of the moving member 52, so that the moving member 52 moves along the axis of the support arm 30 under the action of the threaded portion.

Specifically, as shown in FIG. 4, in some embodiments of the present disclosure, each mounting plate 36 can include a sliding groove, and the two ends of the moving member 52 are respectively slidingly engaged with the two sliding grooves.

As shown in FIGS. 4, 8 and 9, in some embodiments of the present disclosure, the adjustment assembly 50 further comprises an indicator 53. The support arm 30 can include a scale strip 31, the indicator 53 can be located on the moving member 52, and the support arm 30 can include a viewing window 32, such that at least part of the indicator 53 is visible from the exterior through the viewing window 32.

In the embodiment illustrated in FIGS. 4, 8, and 9, the indicator 53 is visible adjacent to the scale strip 31 of the support arm 30 through the viewing window 32, so that the user can immediately see the specific bearing value corresponding to the indicator 53 when adjusting the bearing state of the display device, avoiding the problem of bearing mismatch caused by blind adjustment, and improving the accuracy and efficiency of the adjustment.

Further, by observing the position of the indicator 53 relative to the scale strip 31, the user can quickly adjust to the required bearing setting without a complex measurement or calculation process, simplifying the operation process, reducing the use threshold, and improving the user experience.

In some embodiments of the present disclosure, the number of indicators 53 is two. the indicators 53 can be located on opposing sides of the adjustment assembly 50. The two mounting plates 36 are respectively spaced apart on both sides of the lower connecting arm 35 at an angle to the axis of the adjusting member 51 so as to respectively accommodate the two indicators 53. The two sides of the lower connecting arm 35 are respectively provided with viewing windows 32, and the two viewing windows 32 are respectively arranged corresponding to the two indicators 53. The periphery of the lower connecting arm 35 is provided with a scale showing different weights, so that when the moving member 52 moves on the adjusting member 51, the position of the indication strip can be seen through the viewing windows 32 of the lower connecting arm 35, corresponding to the weight scale.

As shown in FIGS. 4, 7, and 8, in some embodiments of the present disclosure, the support arm 30 includes a clearance hole 33 and the adjustment assembly 50 further comprises a transmission member 54 arranged in the support arm 30. The adjusting member 51 can be connected with the transmission member 54. The transmission member 54 can include an operating end 55. The operating end 55 can be exposed through the clearance hole 33, and the transmission member 54 can drive the adjusting member 51 to rotate by rotating the operating end 55.

In the embodiment illustrated in FIGS. 4, 7, and 8, the operating end 55 can be exposed to the exterior through the clearance hole 33, so that the user can directly rotate the operating end to adjust without disassembling or opening the support arm 30, thereby greatly improving the convenience of user operation, and the user can easily adjust the height of the display device even in a limited space.

Specifically, in the embodiment illustrated in FIGS. 4, 7, and 8, the transmission member 54 is internally connected with the adjusting member 51 such that when the user rotates the operating end 55, force is efficiently transmitted to the adjusting member 51 through the transmission member 54, and the adjusting member 51 is driven to rotate, thereby realizing accurate adjustment of the position of the moving member 52.

Further, the size and position of the clearance hole 33 can be designed to prevent misoperation to a certain extent, as the user can only contact the operating end 55 through a specific clearance hole. Accordingly, adjustment changes caused by accidental touch are reduced, and the use safety of the product is improved.

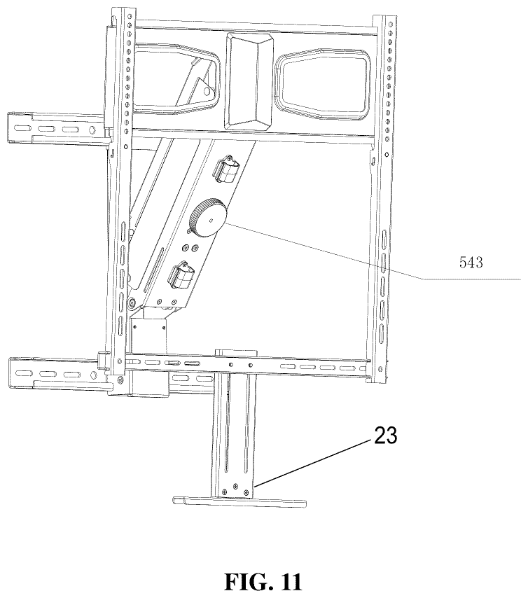

In some embodiments, as shown in FIG. 11, the adjustment assembly 50 (FIGS. 2 and 3) further comprises a knob 543. The knob 543 can be arranged through the clearance hole 33 and connected with the operating end 55, so that the adjustment force value can be selected by the knob 543 instead of a wrench, and adjustment can be realized without tools.

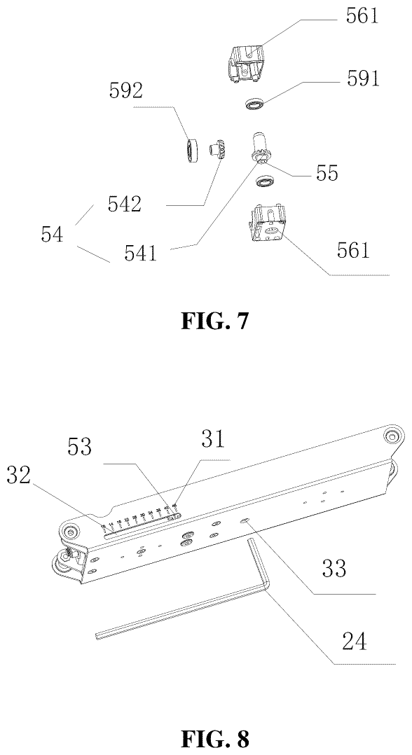

As shown in FIG. 7, in some embodiments of the present disclosure, the transmission member 54 comprises a first gear 541 rotatably arranged in the support arm 30, the first gear 541 being provided with an operating end 55; and a second gear 542 rotatably arranged in the support arm 30, the second gear 542 being in mesh with the first gear 541. The second gear 542 can be connected with the adjusting member 51, and the axis of the first gear 541 can be arranged at an angle to the axis of the second gear 542.

In the embodiment illustrated in FIG. 7, the meshing between the first gear 541 and the second gear 542 can efficiently convert and transmit the rotation force input through the operating end 55 to the adjusting member 51, wherein gear transmission generally has high transmission efficiency, can ensure accurate transmission of force, and makes the position adjustment of the moving member 52 more stable and more rapid in response.

Further, the axis of the first gear 541 can be arranged at an angle with the axis of the second gear 542, so that the direction of force can be changed, and the user can operate the adjustment assembly 50 from a more convenient and natural angle. Even in a limited space, the user can easily adjust the height of the display device, and the convenience and flexibility of operation are improved.

Specifically, in some embodiments of the present disclosure, the outer diameter of the first gear 541 is smaller than the outer diameter of the second gear 542, so that the meshing between the gears has the function of torque amplification, and the small torque input by the external operating end 55 can be converted into the larger torque of the internal adjusting member 51, which enables the user to make accurate adjustment with less force, reduces the physical burden of operation and improves the user experience.

Specifically, in some embodiments of the present disclosure as shown in FIGS. 4 and 7, the adjustment assembly 50 further includes a gearbox 56 mounted in the support arm 30, two second bearings 591 mounted in the gearbox 56, and a third bearing 592 mounted in the gearbox 56. One side of the gearbox 56 is provided with a clearance groove corresponding to the clearance hole 33. The first gear 541 includes a first rotating shaft and a first tooth part connected to the outer periphery of the first rotating shaft, and the two ends of the first rotating shaft are rotatably arranged in the gearbox 56 through the two second bearings 591 respectively. Either end of the first rotating shaft is exposed through the clearance groove and provided with the operating end 55. The second gear 542 includes a second rotating shaft and a second tooth part connected to one end of the second rotating shaft, the second tooth part being in mesh with the first tooth part. The other end of the second rotating shaft is rotatably arranged in the gearbox 56 through the third bearing 592, and the other end of the second rotating shaft is connected with the adjusting member 51, so that the rotation is smoother, wherein the first rotating shaft and the second rotating shaft are arranged at an angle.

In some embodiments of the present disclosure, the gearbox 56 includes two gearbox covers 561 which are detachably connected.

In some embodiments of the present disclosure, the first gear 541 and the second gear 542 are bevel gears.

Specifically, in some embodiments of the present disclosure, the operating end 55 is a hexagonal hole arranged on the first gear 541, and the adjusting tool can be a wrench, so that when the wrench passes through the lower connecting arm 35 and acts on the first gear 541, the second gear 542 rotates to drive the adjusting member 51 to rotate, so that the moving member 52 can axially slide on the adjusting member 51, and the corresponding indicating bar also points to the weight scale, so as to realize the bearing range of the bracket. The clearance hole 33 can be arranged on the lower surface of the lower connecting arm 35 such the position is appropriate, the adjustment space is large, and the adjustment is convenient.

In some embodiments, the adjustment assembly 50 can also be mounted on the upper connecting arm 34.

As shown in FIG. 3, in some embodiments of the present disclosure, the mounting base assembly further includes a connecting member 14 arranged on the mounting base 11. One end of the elastic member 12 away from the transmission mechanism 40 can be connected with the connecting member 14.

Through the arrangement illustrated in FIG. 3, the connecting member 14 can be used to fix the elastic member 12 on the mounting base 11, the stability and firmness of the elastic member 12 when bearing the weight of the display device can be ensured, the problems of structural looseness or instability possibly caused by direct connection are avoided, and the structural safety of the whole bracket is improved.

Specifically, in some embodiments of the present disclosure, the connecting piece 14 is connecting shaft and can be equipped with one or more annular limit slots extending around the connecting shaft. Elastic members 12 can be mounted such that they are engaged within the annular limit slots and can thereby avoid movement of the elastic members 12 along the axis of connecting shaft. Thus, the support stability of elastic members 12 can be improved.

Specifically, in some embodiments of the present disclosure, when pulling the display device downward, the lower connecting arm 35 rotates, and the chain acts on the elastic member 12 by moving relative to the sprocket wheel, thereby stretching the elastic member 12, and the elastic force generated by the elastic member 12 offsets the weight of the display device. When mounting display devices of different weights, the position of the moving member 52 is changed by the adjusting member 51, and the chain connects the elastic member 12 and the moving member 52. Thus, on the one hand, the initial stretching amount of the elastic member 12 can be changed, and on the other hand, the acting point of the elastic force generated by the elastic member 12 on the lower connecting arm 35 through the chain can be changed. Accordingly, the force arm of the elastic force on the rotation of the lower connecting arm 35 is changed. Because the adjustment simultaneously changes the initial elastic force and the acting force arm, the display device can be better matched with display devices of different weights, and the lifting experience is better.

As shown in FIG. 2, in some embodiments of the present disclosure, the panel assembly 20 comprises a panel connector 21 and a panel 22. The support arm 30 is connected with the panel 22 through the panel connector 21 and the panel 22 includes a hanging arm suitable for mounting a display device such as a television set. The mounting base assembly is configured to be connected with a wall plate assembly, and the wall plate assembly is used for being mounted on a wall.

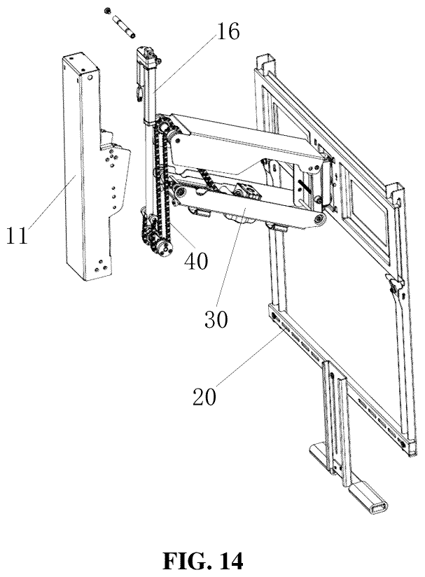

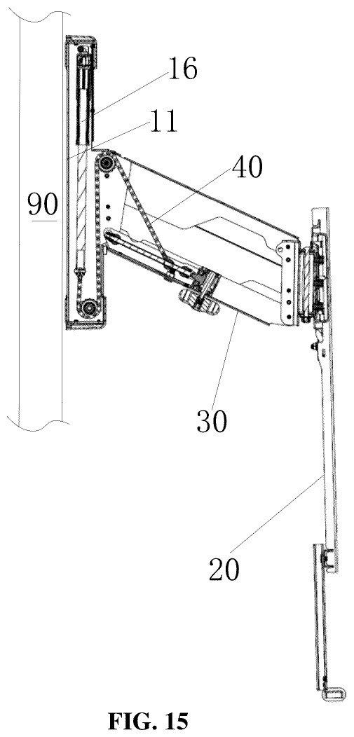

As shown in FIGS. 14-15, the elastic member 12 (FIG. 13) can also be replaced by or further include structures having a telescopic capability. For example, the elastic member 12 can be replaced by a linear actuator 16. The linear actuator 16 includes a housing and a piston rod telescopically movable relative to the housing, the housing is mounted in the mounting base 11, and the outer end of the piston rod is connected to the first end of the transmission mechanism 40. The mounting base 11 is adapted to be mounted against a wall, and the telescopic direction of the piston rod of the linear actuator 16 is substantially parallel to the wall. In some embodiments, the linear actuator 16 can also be inverted such that the outer end of the piston rod is connected to the mounting base 11, and the housing is connected to the first end of the transmission mechanism 40. In other embodiments, the elastic member 12 can also be a gas spring, which includes a housing and a piston rod telescopically movable relative to the housing. In such embodiments, the housing is mounted in the mounting base 11, and the outer end of the piston rod is connected to the first end of the transmission mechanism 40, or the gas spring is inverted head to tail.

In some embodiments, an adjustment assembly 50 is provided in the mounting base 11, the adjustment assembly 50 is provided between the extendable member and the mounting base 11, and the adjustment assembly 50 is used to move the extendable member relative to the mounting base 11. For example, when the housing of the linear actuator 16 is mounted in the mounting base 11, and the outer end of the piston rod is connected to the first end of the transmission mechanism 40, the adjustment assembly 50 can adjust the mounting position of the housing of the linear actuator 16 in the mounting base 11, so that the display device mounting bracket of the present application can be adapted to display devices of different weights.

Optionally, the linear actuator 16 can be in communication with a control device, which can be in communication with to a remote control. Operating the remote control allows the linear actuator 16 to be extended or retracted, thereby allowing the height of the display mounted on the panel assembly 20 to be adjusted.

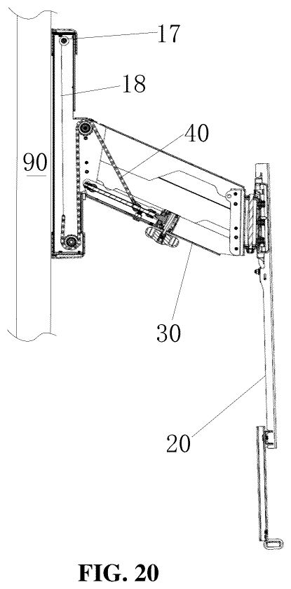

As shown in FIG. 20, in some embodiments, the display device mounting bracket includes a driving device. The driving device includes a motor, and the output end of the motor is provided with a spool 17. The motor is capable of driving the spool 17 to rotate. A first end of the transmission member 40 is connected to a pulling rope 18, and the pulling rope 18 can be wound around the spool 17. When the spool 17 rotates, the length of the pulling rope 18 can be adjusted, thereby adjusting the position of the support arm 30.

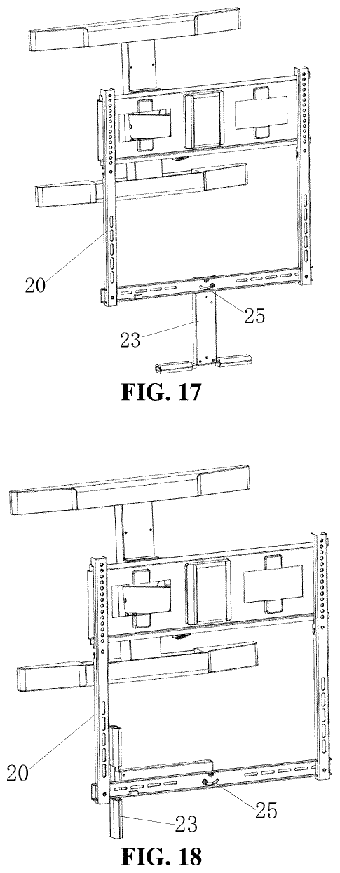

As shown in FIGS. 17-18, the panel assembly 20 can include a hidden or hidable handle 23. The handle 23 can be movable or rotatable relative to the panel assembly 20, such that at least three quarters of the handle 23 can be hidden behind the display when the panel assembly 20 is mounted on the display. Optionally, at least half of the handle 23 can be hidden behind the display. The handle 23 is provided for facilitating the operation of the drop-down display, but the exposed handle can be visually disturbing when the display is viewed or when the display device mounting bracket is in the stowed state. in the present embodiment, part or all of the handle 23 can be hidden behind the display after use, and the structure is more compact and aesthetically pleasing.

Optionally, the panel assembly 20 can include an arcuate hole 25. The handle 23 can be rotatably connected to the panel assembly 20 by a pivot. A pin of the handle 23 can pass through the arcuate hole 25, and can move within the arcuate hole 25 when the handle 23 is rotated. In other embodiments, the handle 23 is slidably connected to the panel assembly 20, and can be pushed upwards to the rear of the display to be hidden. Optionally, the panel assembly 20 can include a mounting structure, and the handle 23 can be telescopically and slidably connected to the mounting structure, so that the handle 23 can telescopically extend relative to the mounting structure.

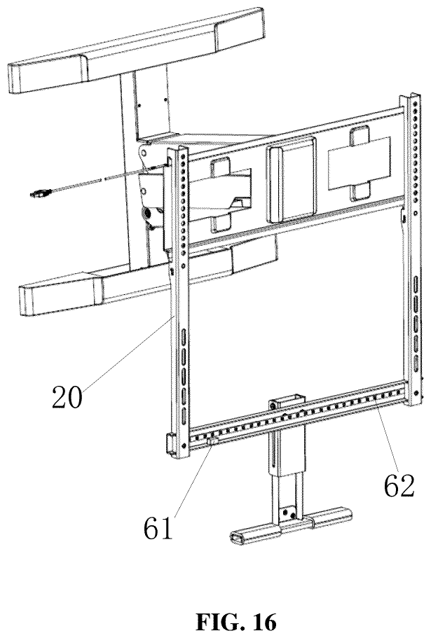

As shown in FIG. 16, the panel assembly 20 can further include a temperature detection device. Since the display device mounting bracket of the present application can be mounted near, above, or in front of a heat source such as a fireplace, excessively high temperatures may be encountered which can be harmful to the display. The temperature detection device can be a temperature sensor 61, which is in communication with the control system. When the temperature is detected to exceed a certain threshold, the control system can output an alarm signal, which can be an audible signal or a light signal. In other embodiments, the control system can also directly control the linear actuator 16 to move, so that the panel assembly 20 is moved away from the fireplace.

In other embodiments, the panel assembly 20 is further provided with a light source 62. The light source 62 can also be mounted on the mounting base 11 or the support arm 30. The light source 62 can improve the viewing atmosphere and enhance the immersive experience, and can also serve as a supplementary light source when the indoor lighting is turned off.

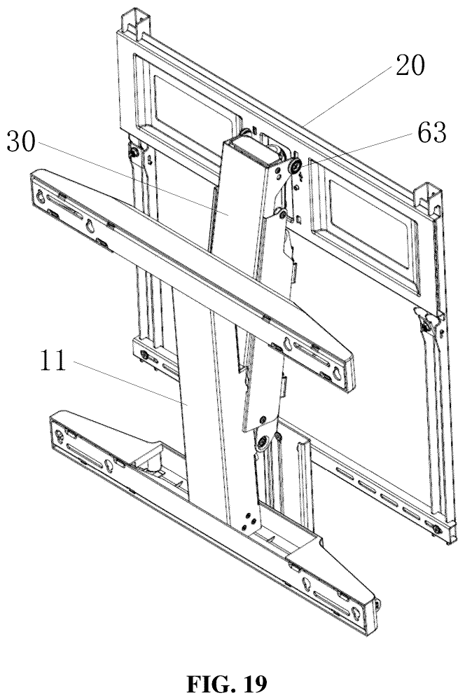

As shown in FIG. 19, one end of the support arm 30 close to the panel assembly 20 can be provided with a limit member 63. The limit member 63 can include a pair of spaced apart rollers and the outer peripheral wall of the roller can be in contact with the rear surface of the panel assembly 20. When the support arm 30 is rotated upward to a storage state, the panel assembly 20 can come into contact with and press against the rollers after the support arm 30 is rotated to a predetermined angle, so that the panel assembly 20 can be rotated relative to the support arm 30 while ensuring that the edge of the display will not hit the wall. Alternatively, the limit member 63 can also be arranged behind the panel assembly 20 such that when the support arm 30 is swung to the storage state, the roller is in contact with and presses the support arm 30, under the action of the reaction force, the panel assembly 20 is rotated relative to the support arm 30. The roller can be replaced by other shaped components to achieve the same function. In other embodiments, the limit member 63 can be arranged at intervals in the vertical direction, arranged at intervals in both the vertical and horizontal directions, or additional limit members 63 can be provided.

From the above description, it can be seen that various embodiments of the present disclosure provides a number of technical effects. For example, the extendable member can be disposed within the base, with one end of the transmission mechanism connected to the support arm and the other end connected to the extendable member inside the base. This arrangement alters the conventional layout in which the extendable member is incorporated into the support arm, thereby reducing the volume and length of the support arm and making it more compact. The display device mounting brackets of the present disclosure may be particularly suitable for use in environments with limited space, such as rooms with low ceilings, and can improve the overall user experience. The above description merely provides example embodiments of the present disclosure and is not intended to limit the scope of the present disclosure. Those skilled in the art will recognize that various modifications, equivalent substitutions, and improvements can be made without departing from the spirit and scope of the present disclosure.

What is claimed is:

1. A display device mounting bracket, comprising:
a mounting base assembly comprising a mounting base;
a panel assembly;
a cantilever assembly comprising a support arm and a transmission mechanism, two ends of the support arm being rotatably connected to the mounting base and the panel assembly, respectively;
an extendable member mounted in the mounting base, a first end of the transmission mechanism being connected to the extendable member, and a second end of the transmission mechanism acting on the support arm; and
an adjustment assembly provided on the support arm, the adjustment assembly being configured to move the second end of the transmission mechanism on the support arm to adapt to display devices of different weights, the extendable member providing a supporting force for keeping the support arm at any position via the transmission mechanism.

2. The display device mounting bracket of claim 1, wherein the adjustment assembly comprises:
an adjusting member provided on the support arm; and
a moving member threadedly connected to the adjusting member, the transmission mechanism being connected to the moving member, and the moving member moving relative to the support arm by rotating the adjusting member to change a position of an action point of the extendable member on the support arm.

3. The display device mounting bracket of claim 2, wherein:
the moving member is slidingly fitted to the support arm; and/or
the adjustment assembly further comprises an indicator, the support arm is provided with a scale strip, the moving member comprises the indicator, the support arm comprises a viewing window, and at least part of the indicator is shown through the viewing window.

4. The display device mounting bracket of claim 2, wherein the support arm comprises a clearance hole, the adjustment assembly further comprising a transmission member provided in the support arm, the adjusting member being connected to the transmission member, the transmission member comprising an operating end, the operating end being visible through the clearance hole, and the transmission member driving the adjusting member to rotate by rotating the operating end.

5. The display device mounting bracket of claim 4, wherein the transmission member comprises:
a first gear rotatably arranged on the support arm, wherein the first gear comprises the operating end; and
a second gear rotatably arranged on the support arm, wherein the second gear is in meshing connection with the first gear, the second gear is connected with the adjusting member, and an axis of the first gear and an axis of the second gear are arranged at an angle.

6. The display device mounting bracket of claim 1, wherein the mounting base assembly further comprises at least one guide member rotatably connected to the mounting base, and the transmission mechanism is wound around the at least one guide member.

7. The display device mounting bracket of claim 6, wherein:
the guide member includes at least one sprocket, and the transmission mechanism includes at least one chain; or
the guide member includes at least one pulley, and the transmission mechanism includes at least one driving rope.

8. The display device mounting bracket of claim 6, wherein the mounting base assembly comprises a plurality of guide members, at least two of the guide members are arranged in a staggered manner in a direction from the mounting base to the panel assembly, the transmission mechanism is wound around the at least two guide members in sequence, and a first guide member of the at least two guide members is located below the extendable member.

9. The display device mounting bracket of claim 6, wherein the mounting base comprises:
a rear plate;
two side plates, wherein the two side plates are arranged at intervals on the rear plate, each of the side plates comprising a base plate and a baffle plate connected to the base plate, and the support arm is connected to the two baffle plates or to the two base plates;
an upper cover plate connected to the base plate; and
a lower cover plate connected to the base plate, wherein the upper cover plate and the lower cover plate are respectively located on two sides of the support arm, and the rear plate, the two side plates, the upper cover plate, the lower cover plate and the support arm form an enclosed space, the at least one guide member being connected between the two baffle plates, and the extendable member is mounted between the two base plates.

10. The display device mounting bracket of claim 9, wherein:
the upper cover plate comprises a first plate section, a second plate section and a third plate section connected in sequence and arranged at an angle, the first plate section and the third plate section are located on both sides of the second plate section, the first plate section is located on top of the two base plates, the second plate section is located on the front side of the two base plates, and the third plate section is located on top of the two baffle plates; and
the lower cover plate comprises a fourth plate section and a fifth plate section connected and arranged at an angle, the fourth plate section is located on the front side of the two base plates and below the two baffle plates, and the fifth plate section is located on the bottom of the two base plates, and the support arm is rotatably connected with the two baffle plates.

11. The display device mounting bracket of claim 1, wherein the support arm comprises:
an upper connecting arm pivotally connected with the mounting base and the panel assembly at two ends thereof, respectively;
a lower connecting arm pivotally connected with the mounting base and the panel assembly at two ends thereof, respectively, the upper connecting arm, the panel assembly, the lower connecting arm and the mounting base forming a quadrilateral mechanism; and/or
the mounting base assembly further comprises a connecting member arranged on the mounting base, and an end of the extendable member away from the transmission mechanism is connected with the connecting member.

12. The display device mounting bracket of claim 1, wherein the extendable member is an elastic member, and the elastic member is a mechanical spring or a gas spring.

13. The display device mounting bracket of claim 1, wherein the extendable member is a linear actuator.

14. The display device mounting bracket of claim 1, wherein a handle is arranged on the panel assembly, the handle is movable or rotatable relative to the panel assembly, and a portion or the entirety of the handle can be hidden behind the display when the panel assembly is mounted on the display.

15. The display device mounting bracket of claim 1, wherein a temperature detecting device is arranged on the panel assembly or on a handle arranged on the panel assembly.

16. The display device mounting bracket of claim 1, wherein at least one of the mounting base, the panel assembly and the support arm has a light source thereon.

17. The display device mounting bracket of claim 1, wherein a limit member is disposed on one of the support arm and the panel assembly, and wherein when the support arm is swung to a storage state, the limit member is in contact with the other of the support arm and the panel assembly to drive the panel assembly to rotate.

18. A display device mounting bracket, comprising:
a mounting base assembly comprising a mounting base adapted to be mounted on a wall;
a panel assembly;
a cantilever assembly comprising a support arm and a transmission mechanism, two ends of the support arm being rotatably connected to the mounting base and the panel assembly respectively;
an extendable member, an expansion direction of the extendable member being substantially parallel to the wall, a first end of the transmission mechanism being connected to the extendable member and a second end of the transmission mechanism being connected to the support arm; and
an adjustment assembly provided on the support arm, the adjustment assembly being configured to move the second end of the transmission mechanism on the support arm to adapt to display devices of different weights, the extendable member providing a support force for keeping at any position to the support arm through the transmission mechanism.

19. A display device mounting bracket, comprising:
a mounting base assembly comprising a mounting base;
a panel assembly;
a cantilever assembly comprising a support arm and a transmission mechanism, two ends of the support arm being rotatably connected to the mounting base and the panel assembly respectively;
a driving device, the driving device being mounted on the base, a first end of the transmission mechanism being connected to the driving device and a second end of the transmission mechanism being connected to the support arm; and
an adjustment assembly provided on the support arm, the adjustment assembly being configured to move the second end of the transmission mechanism on the support arm to adapt to display devices of different weights, the actuating device providing a support force for keeping at any position to the support arm through the transmission mechanism.
